(19) United States
(12) Patent Application Publication
(10) Pub. No.: US 2016/0122597 A1
(43) Pub. Date: May 5, 2016

(54) PREPARATION OF PRESSURE SENSITIVE ADHESIVE DISPERSIONS FROM MULTI-STAGE EMULSION POLYMERIZATION FOR APPLICATIONS OF PROTECTIVE FILMS

(71) Applicant: BASF SE, Ludwigshafen (DE)

(72) Inventors: Edward Shude XIAO, Shanghai (CN); Jeff Jianfeng XIA, Shanghai (CN); Jianhua SUN, Shanghai (CN); Yiming CHEN, Shanghai (CN)

(73) Assignee: BASF SE, Ludwigshafen (DE)

(21) Appl. No.: 14/892,898

(22) PCT Filed: May 12, 2014
(86) PCT No.: PCT/EP2014/059640

§ 371 Date: Nov. 20, 2015

(30) Foreign Application Priority Data
May 21, 2013 (CN) PCT/CN2013/075984

(51) Int. Cl. C09J 133/08; C09J 7/02

(52) U.S. Cl. CPC C09J 133/08; C09J 7/0217; C09J 2201/122; C09J 2201/606; C09J 2205/114; C09J 2433/00

(57) ABSTRACT

The invention describes a preparation process of pressure sensitive adhesives, wherein a multi-stage emulsifier-free emulsion polymerization and applications of the obtained dispersions for pressure sensitive protective films are included. At least one carboxylic acid group containing monomer is used in the first stage of emulsion polymerization. The theoretical glass transition temperatures are lower than 0° C. (for the first stage polymer), −20° C. (for the second stage polymer) and −15° C. (for the overall dispersion), respectively. The dispersion is preferably cross-linked with polyfunctional crosslinking agents, such as aziridine, isocyanate, carbodiimide and oxazoline. The adhesives obtained from the process thereof can be used for the application of protective films to reduce or eliminate ghost shadow on the protected surfaces.

### FIELD OF THE INVENTION

The present invention relates to a process for preparing a pressure sensitive adhesive dispersion. In particular, it relates to a process for preparing a pressure sensitive adhesive dispersion for protection of surfaces by a multi-stage emulsion polymerization, and the pressure sensitive adhesive dispersion prepared therefrom.

### BACKGROUND OF THE INVENTION

Protective films are used to temporarily protect the surfaces of articles or products from scratches or pollutions, and they can find their applications in industrial processing and in surface protection of final products before the usage. Though the adhesion strength (e.g. tack and peel) to a protected surface can be varied to meet the requirements of different applications, one common criterion is shared in most practices, i.e. when the protective film is removed, there should be no residue on the protected surface. The residual specimen from the adhesive on the protected surface can cause the “ghost shadow” that is commonly referred to as “ghosting” or “shadow”.

“Ghosting” can happen with hot melt, solvent-borne, and polymer dispersion adhesives, which, though not quite clear, may be attributed to small molecules, oligomers, or low molecular weight short-chained polymers. In some special applications, a “ghost shadow” is problematic, in particular when a protective film is used on a glossy surface.

In recent years, scientists in the art are making great efforts to find a way to reducing or eliminating the “ghost shadow”. Crosslinking of the adhesives, for instance, can help reduce ghosting. Nevertheless, appropriate chemistry or physical means should be further applied so as to restrain the low molecular weight species from migration to a protected surface. Since a common adhesive dispersion is generally made from an emulsion polymerization using an emulsifier (a surfactant) or stabilized with a protective colloid of low molecular weight, a protective film adhesive made of such dispersion can hardly avoid the ghost shadow problem, even when the adhesive has been crosslinked to some extent.

WO2011/154920A1 discloses a process for preparing aqueous polymer dispersions for producing composite films by a multistage emulsion polymerization. The object thereof was to prepare aqueous polymer dispersions which can be used to produce composite films having very good instantaneous adhesion and very good heat stability. WO2011/154920A1 does not solve the “ghost shadow” problem for protective films.

US2012/0077030A1 discloses the multistage emulsion polymerization preparation of aqueous pressure-sensitive adhesive dispersions for producing self-adhesive articles. The object was to provide aqueous PSA dispersions having as small an emulsifier content as possible, having good adhesion and cohesion, and forming as little coagulum as possible. US2012/0077030A1 does not have the effect of avoiding ghost shadow and adhesive residue on the metal surface.

WO2012/038202A1 discloses a process for preparing an aqueous pressure-sensitive adhesive dispersion via multistage free-radical emulsion polymerization. The obtained aqueous pressure-sensitive adhesive dispersions can be used for producing self-adhesive articles, especially self-adhesive labels and adhesive tapes. WO2012/038202A1 does not aim at avoiding “ghost shadow” on protective films.

CN200610077426.2 discloses a pressure sensitive adhesive that can be readily removed from sensitive surfaces without significant ghosting, exhibit good wet out and are easy and cheap to prepare. However, CN200610077426.2 does not relates to a process for preparing the pressure sensitive adhesive via multi-stages of emulsion polymerization, and the pressure sensitive adhesive of CN200610077426.2 is completely different from the pressure sensitive adhesive obtained in the present invention.

An in-situ made protective colloid from a multi-stage emulsion polymerization is a promising solution for reducing or eliminating the ghost shadow, because 1) no emulsifier is used during the polymerization, and 2) the molecular weight and functionality of the protective colloid prepared therefrom can be easily controlled and adjusted for further treatments or modifications.

Functional groups, such as carboxylic acid groups and hydroxyl groups, that are incorporated into the dispersions through copolymerization of functional monomers, offer much flexibility to different crosslinking mechanisms as well as adjustable crosslinking degrees. These functional groups, when coupled with multi-functional crosslinking agents, such as aziridine, isocyanate, oxazoline and carbodiimide, can be utilized as a two-component crosslinking system. A pressure sensitive adhesive dispersion obtained from such an emulsifier-free multi-stage emulsion polymerization is provided to solve the “ghost shadow” problem for protective films.

### SUMMARY

The present invention provides a preparation process of a pressure sensitive adhesive dispersion via a multi-stage emulsion polymerization. A protective film coated with the pressure sensitive adhesive dispersion of the invention can avoid the “ghost shadow” on the protected surface when removed from the protected surface, through reduced—amount of low molecular weight species in the adhesive, particularly no emulsifiers engaged during the polymerization process. The process of the invention comprises: a. preparing a protective colloid in a first stage of the emulsion polymerization, during which no extra emulsifier is used; b. obtaining a dispersion for preparing pressure sensitive adhesives after a second stage of the emulsion polymerization, wherein the polymers obtained from the emulsion polymerization contain functional groups that can be crosslinked during the coating and drying processes when the pressure sensitive adhesives are formed; and preferably c. cross-linking the polymers obtained from the emulsion polymerization with a crosslinking agent.

The pressure sensitive adhesive dispersion obtained from the process of the invention successfully avoids the “ghost shadow” on the protected surface. For example, in an embodiment of the invention, the pressure sensitive adhesive from the pressure sensitive adhesive dispersion of the invention or from the pressure sensitive adhesive formulation of the invention shows not only good anchorage on a polyethylene film but also good cohesion, and avoid occurrence of adhesives cohesive failure and adhesives transfer, thereby adhesive residues on the stainless steel surface are eliminated.

In another embodiment of the invention, no visible ghost shadow is present on a stainless steel surface after a protective film of the invention is removed, wherein the protective film of the invention is obtained from applying the pressure sensitive adhesive dispersion of the invention or the pressure sensitive adhesive formulation of the invention onto a film.

### DETAILED DESCRIPTION

Generally, the present invention relates to a process for preparing a pressure sensitive adhesive dispersion via a multi-stage emulsion polymerization.

Unless defined otherwise, all technical and scientific terms used herein have the same meaning as commonly understood by one of ordinary skill in the art to which this invention belongs.

Expressions “a”, “an”, “the”, when used to define a term, include both the plural and singular forms of the term.

In present invention, when used, the term “ethylenically unsaturated monomers” means mono-ethylenically unsaturated monomers.

The term “ethylenically unsaturated monomers” in the present invention, when used, is independent from the term “carboxylic acid group containing-ethylenically unsaturated monomer” of the invention.

In the first aspect of the invention, the present invention relates to a process for preparing a pressure sensitive adhesive dispersion, comprising:

1) a first stage of a emulsion polymerization, comprising
i) in an aqueous medium, obtaining a first-stage polymer particle from a first-stage monomer composition consisting of ethylenically unsaturated monomers and at least one carboxylic acid group containing ethylenically unsaturated monomer, to form a first-stage dispersion, wherein the carboxylic acid group containing ethylenically unsaturated monomer is included in an amount of at least 1.0 wt % (preferably 10-30 wt %) of the first-stage monomer composition;
ii) adding a chain transfer agent to the first-stage monomer composition, wherein the added amount of the chain transfer agent is in the range of 0.3-1.5 wt %, preferably 0.3-1.1 wt %, based on the weight of the first-stage monomer composition;
iii) neutralizing the first-stage dispersion with an aqueous base solution to the pH value of between 5.0 and 7.0, preferably between 6.0 to 7.0,

2) a second stage of the emulsion polymerization, wherein in the presence of the neutralized first-stage dispersion, a second-stage monomer composition consisting of ethylenically unsaturated monomers and optionally at least one multi-ethylenically unsaturated monomer, is polymerized into the first-stage polymer particles to form the second-stage polymer particles, thereby obtaining the pressure sensitive adhesive dispersion,
wherein the weight ratio of the first-stage monomer composition to the total of the first-stage monomer composition and the second-stage monomer composition should be in the range of 5-50 wt %, preferably 8-30 wt %, such as 10-20 wt %.

Without intending to be bond to any theory, it is believed that in the first stage of emulsion polymerization, the first-stage monomer composition forms the first-stage polymer particles, and then, in the second stage of emulsion polymerization, the second-stage monomer composition polymerizes into the first-stage polymer particles to form the pressure sensitive adhesive dispersion of the invention.

The multi-stage emulsion polymerization of the invention takes place in an aqueous medium, and no emulsifier is used. In the first stage of the emulsion polymerization, the carboxylic acid group containing ethylenically unsaturated monomers are copolymerized with ethylenically unsaturated monomers of the first-stage monomer composition, to form the first-stage polymer particles with acid groups. When these acid groups are neutralized to a higher pH value but less than or equal to 7.0, such as pH value of between 5.0 and 7.0, preferably between 6.0 to 7.0, the hydrophilicity of the first-stage polymer particles will increase so as to act as a protective colloid for the second stage emulsion polymerization and, toward the end of the polymerization, to be able to stabilize the polymer dispersion with high solids content. The number-average molecular weight of the obtained protective colloids should be above 2000 g/mol, and preferably within the range of 10,000-50,000 g/mol.

Preferably, in the multi-stage emulsion polymerization of the invention, seed particles may be contained in the initial charge to the first stage of the emulsion polymerization to precisely control the size of the polymer particles. For example, in this first stage, seed dispersions, e.g. polystyrene seed dispersion, can be included in the initial charge of the polymerization reactor to better control the particle size of the final dispersions.

In the pressure sensitive adhesive dispersion of the invention, the weight ratio of the first-stage monomer composition to the total of the first-stage monomer composition and the second-stage monomer composition should be in the range of 5-50 wt %, preferably 8-30 wt %, such as 10-20 wt %.

The suitable ethylenically unsaturated monomers of the first-stage monomer composition can be one or a combination of, but not limited to, (meth)acrylates with/without functional groups (e.g. 2-ethylhexyl acrylate, butyl acrylate, ethyl acrylate, methyl acrylate, methyl methacrylate, 2-hydroxyethyl acrylate, 2-hydroxypropyl acrylate, ureido methacrylate, glycidyl methacrylate, acetoacetoxyethyl methacrylate, hydroxypropylcarbamate acrylate and SIPOMER® β-CEA (from Solvay Rhodia, Singapore)), vinyl and allyl monomers with/without functional groups (e.g. styrene, vinyl acetate, VeoVa™ 9 (from Momentive, Gahanna, Ohio, USA), VeoVa™ 10 (from Momentive, Gahanna, Ohio, USA), VeoVa™ EH (from Momentive, Gahanna, Ohio, USA), Golpanol® VS (from BASF SE. Ludwigshafen, Germany), SIPOMER® COPS-I (from Solvay Rhodia, Singapore), SIPOMER® AAE-10 (from Solvay Rhodia, Singapore) and SIPOMER® AES-100 (from Solvay Rhodia, Singapore)), and other functional ethylenically unsaturated monomers (e.g. SIPOMER® PAM-100 (from Solvay Rhodia, Singapore), LATEMUL PD-420 (from KAO Chemical, Shanghai, China), LATEMUL PD-450 (from KAO Chemical, Shanghai, China), N-methylolacrylamide (from Sigma-Aldrich, St. Louis, Mo., USA) and diacetone acrylamide (from Sigma-Aldrich, St. Louis, Mo., USA) (paired with adipic dihydrazide (from Sigma-Aldrich, St. Louis, Mo., USA) via addition of adipic dihydrazide to the final dispersion)).

As stated above, in the process of the invention, monomers suitable for the first-stage monomer composition may be used in combination; and monomers suitable for the second-stage monomer composition may be used in combination. For example, combinations of two or more monomers suitable for being used as ethylenically unsaturated monomers of the first-stage monomer composition may be applicable to the process of the invention. Combination of different ethylenically unsaturated monomers can not only control the glass transition temperature of the copolymers thus adjusting the performance of the adhesives, but also provide functional groups to improve the functionalities of the obtained dispersions. For example, SIPOMER® COPS-I, SIPOMER® AAE-10, SIPOMER® AES-100, SIPOMER® β-CEA, LATEMUL PD-420, LATEMUL PD-450 and Golpanol® VS are applicable for better dispersion stability; glycidyl methacrylate, N-methylolacrylamide and diacetone acrylamide (paired with adipic dihydrazide) are applicable for crosslinking; and VeoVa™ 9, VeoVa™ 10, VeoVa™ EH, SIPOMER® PAM100 and ureido methacrylate are applicable for offering special properties such as good water whitening resistance and high polarity for physical “crosslinking” to the obtained adhesives thereafter. In an embodiment of the invention, one or more of monomers selected from the group consisting of SIPOMER® COPS-I, SIPOMER® AAE-10, SIPOMER® AES-100, SIPOMER® β-CEA, LATEMUL PD-420, LATEMUL PD-450 and Golpanol® VS are used in combination with one or more of monomers selected from the group consisting of glycidyl methacrylate, N-methylolacrylamide, diacetone acrylamide (paired with adipic dihydrazide via addition of adipic dihydrazide to the final dispersion), VeoVa™ 9, VeoVa™ 10, VeoVa™ EH, SIPOMER® PAM-100 and ureido methacrylate.

When diacetone acrylamide is used as the ethylenically unsaturated monomers in the present invention, adipic dihydrazide should be added into the obtained pressure sensitive adhesive dispersion after the multi-stage emulsion polymerization of the invention, which means that diacetone acrylamide, when used, should be paired with adipic dihydrazide, via addition of adipic dihydrazide to the dispersion, to obtain the final pressure sensitive adhesive dispersion.

The suitable carboxylic acid group containing ethylenically unsaturated monomers in the first-stage monomer composition can be selected from ethylenically unsaturated acid monomers and the combination thereof, such as acrylic acid, methacrylic acid, itaconic acid and the combination thereof. At least one carboxylic acid group containing ethylenically unsaturated monomers should be included at this stage of emulsion polymerization, and the amount should be preferably at least 1.0 wt % of the first-stage monomer composition in the first stage of polymerization to guarantee good dispersion stability and to provide enough functionality for the cross-linking step thereafter.

The suitable bases for the neutralizing step in the first stage of emulsion polymerization can be one or a combination of aqueous inorganic bases, for example, but not limited to, sodium hydroxide, potassium hydroxide and ammonia water. A high pH value at this stage may affect the efficiency of the initiators, and a pH value of <7.0 is preferable.

A chain transfer agent is a must for the first stage of emulsion polymerization. The suitable chain transfer agent can be one or a combination of, but not limited to tertiary dodecyl mercaptan and 2-ethylhexyl thioglycolate, whose preferable amount should be in the range of 0.3-1.5 wt %, preferably 0.3-1.1 wt %, based on the weight of the first-stage monomer composition.

In the second stage of emulsion polymerization, the second-stage monomer composition is polymerized into the first-stage polymer particles formed from the first stage of emulsion polymerization.

The suitable ethylenically unsaturated monomers in the second-stage monomer composition are one or a combination of, but not limited to (meth)acrylates with/without functional groups (e.g. 2-ethylhexyl acrylate, butyl acrylate, ethyl acrylate, methyl acrylate, methyl methacrylate, 2-hydroxyethyl acrylate, 2-hydroxypropyl acrylate, ureido methacrylate, glycidyl methacrylate, acetoacetoxyethyl methacrylate, hydroxypropylcarbamate acrylate and SIPOMER® β-CEA), vinyl and allyl monomers with/without functional groups (e.g. styrene, vinyl acetate, VeoVa™ 9, VeoVa™ 10, VeoVa™ EH, Golpanol® VS, SIPOMER® COPS-I, SIPOMER® AAE-10 and SIPOMER® AES-100), and other functional ethylenically unsaturated monomers (e.g. SIPOMER® PAM-100, LATEMUL PD-420, LATEMUL PD-450, N-methylolacrylamide and diacetone acrylamide paired with adipic dihydrazide via addition of the adipic dihydrazide to the obtained pressure sensitive adhesive dispersion).

The suitable multi-ethylenically unsaturated monomers in the second-stage monomer composition, when necessary, are selected from the group consisting of divinylbenzene, allyl methacrylate, diethylene glycol dimethacrylate, Laromer® BDDA, trimethylolpropane trimethacrylate and other multi-ethylenically unsaturated monomers.

Water soluble initiators, including thermal initiators and redox initiators, e.g. sodium persulfate, potassium persulfate, ammonium persulfate, sodium acetone bisulfite/tert-butyl hydroperoxide and sodium bisulfite/sodium persulfate, may be used during the multi-stage emulsion polymerization as well as the deodorization process after the polymerization.

The emulsion polymerization of the present invention may take place at any temperature suitable for an emulsion polymerization, for example, at a temperature in a range of 65-95° C., preferably 75-90° C., and more preferably 80-85° C.

The pressure sensitive adhesive dispersion prepared from the process of the invention has a solid content of 40-56%, and a pH value of 5.0-9.5. The average particle size of the polymer particles dispersed in the pressure sensitive adhesive dispersion is adjustable within the range of 140-350 nm. In present invention, the glass transition temperature of the first-stage polymer is lower than 0° C.; the glass transition temperature of the second-stage polymer is lower than −20° C.; and the glass transition temperature of the overall dispersion polymer is lower than −15° C.

Fox equation is provided according to Fox (T. G. Fox, Bull. Am. Phys. Soc. 1956 [Ser. II] 1, page 123, and in accordance with Ullmann's Encyclopadie der technischen Chemie, Volume 19, page 18, 4th Edition, Verlag Chemie, Weinheim, 1980), the calculation of the glass transition temperature of polymers is subject in good approximation to the following equation:

1/Tg=x₁/Tg₁+x₂/Tg₂+ . . . xₙ/Tgₙ,

where x₁, x₂, . . . xₙ are the mass fractions of the monomers 1, 2, . . . n and Tg₁, Tg₂, . . . Tₙ are the glass transition temperatures of the polymers synthesized in each case only from one of the monomers 1, 2, . . . n, in degrees Kelvin. The Tg values for the homopolymers of the majority of monomers are known and are listed in, for example, Ullmann's Ecyclopedia of Industrial Chemistry, Vol. 5, Vol. A21, page 169, VCH Weinheim, 1992; other sources of glass transition temperatures of homopolymers include, for example, J. Brandrup, E. H. Immergut, Polymer Handbook, 1st Edition, J. Wiley, New York 1966, 2nd Edition, J. Wiley, New York 1975, and 3rd Edition, J. Wiley, New York 1989.

The present invention also relates to the pressure sensitive adhesive dispersion prepared by the process of the invention.

In another aspect of the invention, the present invention relates to a process for preparing a pressure sensitive adhesive formulation, comprising steps of: adding a crosslinking agent to the pressure sensitive adhesive dispersion prepared from the process of the invention.

Optionally, one or more additional additives such as a wetting agent e. g. Lumiten® I-SC and a thickener may be added into the process of this aspect. There is no particular requirement on the additional additives, provided that they can be used for the purpose of the invention.

In a preferred embodiment of the process for preparing a pressure sensitive adhesive formulation of the invention, when the pressure sensitive adhesive dispersion prepared from the process of the invention has a pH value of <7.0, then preferably, before the step of adding a cross-linking agent to the pressure sensitive adhesive dispersion, the process for preparing a pressure sensitive adhesive formulation of the invention further comprises a step of neutralizing the pressure sensitive adhesive dispersion prepared from the process of the invention with a base to a pH value of >7.0, preferably below 10.

The base used for neutralization may be any base suitable for the purpose of the invention, e.g. ammonia water, potassium hydroxide and sodium hydroxide, preferably in form of aqueous solution.

In the process for preparing a pressure sensitive adhesive formulation of the invention, a crosslinking agent is added into the pressure sensitive adhesive dispersion of the invention and well mixed. The crosslinking agent suitable for the purpose of the invention is capable of reacting with carboxylic acid or carboxylate in polymers obtained by the multi-stage emulsion polymerization of the invention. Preferably the cross-linking agent is selected from the group consisting of multi-functional aziridine, isocyanate, oxazoline, carbodiimide and combinations thereof, e.g. Crosslinker® CX-100 (DSM NeoResins, Zwolle, The Netherlands), XAMA®7 (ICHEMCO s.r.l., Cuggiono (MI), Italy), Basonat® DS 3582 (BASAF SE, Ludwigshafen, Germany), Basonat® LR 9056 (BASAF SE, Ludwigshafen, Germany), or HYCASYL™ 510 (Rhein Chemie, Mannheim, Germany). The amount of the crosslinking agent suitable for the process of the invention theoretically corresponds to the amount of carboxylic acid or carboxylate in polymers obtained by the multi-stage emulsion polymerization of the invention. Preferably, the amount of the crosslinking agent is in the range of 0 to 10% by weight, preferably 0 to 8% by weight, more preferably 0.5 to 5% by weight, such as 1 to 3% by weight, based on the total weight of the pressure sensitive adhesive formulation of the invention.

The present invention further relates to a pressure sensitive adhesive formulation obtained from the process for preparing a pressure sensitive adhesive formulation of the invention.

In a further aspect, the present invention relates to a substrate coated with the pressure sensitive adhesive dispersion of the invention or the pressure sensitive adhesive formulation of the invention. The substrate may be any substrate suitable for applying an adhesive, preferably the substrate is selected from the group consisting of tape, sheet, film, plate, and the like, more preferably the substrate is a protective film.

Furthermore, the present invention relates to the use of the pressure sensitive adhesive dispersion of the invention or the pressure sensitive adhesive formulation of the invention for preparing a protective film.

The pressure sensitive adhesive dispersion and the pressure sensitive adhesive formulation obtained from the present processes successfully eliminate the “ghost shadow”. For example, when a protective film coated with the pressure sensitive adhesive dispersion obtained from the present process applied to the surface of a stainless steel test panel under the ambient and harsh ageing conditions, the protective film does not produce ghost shadow on the surface after being removed from the surface, and there exists no adhesive residue on the metal surface. The pressure sensitive adhesive formulation obtained from the present process produces the same result.

In some preferred embodiments of the invention, the properties of the pressure sensitive adhesive dispersion and the pressure sensitive adhesive formulation of the invention such as tack and peel strength can be adjusted by changing the combination of monomers (to affect the glass transition temperature) and by adjusting the molecular weights and/or crosslinking degrees during the polymerization stages (with multi-ethylenically unsaturated monomers) and formulation/coating processes (with external crosslinking agents).

In summary, the present invention relates to following embodiments:

1. a process for preparing a pressure sensitive adhesive dispersion, comprising:

1) a first stage of a emulsion polymerization, comprising
i) in an aqueous medium, obtaining a first-stage polymer particle from a first-stage monomer composition consisting of ethylenically unsaturated monomers and at least one carboxylic acid group containing ethylenically unsaturated monomer, to form a first-stage dispersion, wherein the carboxylic acid group containing ethylenically unsaturated monomer is included in an amount of at least 1.0 wt % (preferably 10-30 wt %) of the first-stage monomer composition;
ii) adding a chain transfer agent to the first-stage monomer composition, wherein the added amount of the chain transfer agent is in the range of 0.3-1.5 wt %, preferably 0.3-1.1 wt %, based on the weight of the first-stage monomer composition;
iii) neutralizing the first-stage dispersion with an aqueous base solution to the pH value of between 5.0 and 7.0, preferably between 6.0 to 7.0,

2) a second stage of the emulsion polymerization, wherein in the presence of the neutralized first-stage dispersion, a second-stage monomer composition consisting of ethylenically unsaturated monomers and optionally at least one multi-ethylenically unsaturated monomer, is polymerized into the first-stage polymer particles to form the second-stage polymer particles, thereby obtaining the pressure sensitive adhesive dispersion,

wherein the weight ratio of the first-stage monomer composition to the total of the first-stage monomer composition and the second-stage monomer composition is in the range of 5-50 wt %, preferably 8-30 wt %, such as 10-20 wt %.

2. the process of embodiment 1, wherein a water soluble initiator is used in the emulsion polymerization, preferably the water soluble initiator is selected from the group consisting of thermal initiators and redox initiators, e.g. sodium persulfate, potassium persulfate, ammonium persulfate, sodium acetone bisulfite/tert-butyl hydroperoxide and sodium bisulfite/sodium persulfate.

3. The process of any one of embodiments 1 to 2, wherein the multi-ethylenically unsaturated monomer is used in an amount of 0.3-2.0 wt %, preferably 0.5-1.6 wt % of the second-stage monomer composition.

4. The process of any one of embodiments 1 to 3, wherein the ethylenically unsaturated monomers of the first-stage monomer composition are selected from the group consisting of (meth)acrylates with/without functional groups, vinyl and allyl monomers with/without functional groups, other functional ethylenically unsaturated monomers and combinations thereof, preferably the ethylenically unsaturated monomers of the first-stage monomer composition other than the carboxylic acid group containing ethylenically unsaturated monomers are selected from the group consisting of 2-ethylhexyl acrylate, butyl acrylate, ethyl acrylate, methyl acrylate, methyl methacrylate, 2-hydroxyethyl acrylate, 2-hydroxypropyl acrylate, ureido methacrylate, glycidyl methacrylate, acetoacetoxyethyl methacrylate, hydroxypropylcarbamate acrylate, SIPOMER® β-CEA, styrene, vinyl acetate, VeoVa™ 9, VeoVa™ 10, VeoVa™ EH, Golpanol® VS, SIPOMER® COPS-I, SIPOMER® AAE-10 and SIPOMER® AES-100, SIPOMER® PAM-100, LATEMUL PD-420, LATEMUL PD-450, N-methylolacrylamide and diacetone acrylamide paired with adipic dihydrazide via addition of adipic dihydrazide to the obtained dispersion;

wherein the carboxylic acid group containing ethylenically unsaturated monomers of the first-stage monomer composition are selected from the group consisting of acrylic acid, methacrylic acid and itaconic acid, and combinations thereof;

wherein the ethylenically unsaturated monomers of the second-stage monomer composition are selected from the group consisting of 2-ethylhexyl acrylate, butyl acrylate, ethyl acrylate, methyl acrylate, methyl methacrylate, styrene, vinyl acetate, VeoVa™ 10, 2-hydroxyethyl acrylate, 2-hydroxypropyl acrylate, SIPOMER® COPS-I, LATEMUL PD-450, Golpanol® VS, ureido methacrylate, glycidyl methacrylate, diacetone acrylamide paired with adipic dihydrazide via addition of the adipic dihydrazide to the obtained dispersion, and carboxylic acid group containing ethylenically unsaturated monomers, such as acrylic acid, methacrylic acid and itaconic acid, and combinations thereof; and

wherein the multi-ethylenically unsaturated monomers are selected from the group consisting of divinylbenzene, allyl methacrylate, diethylene glycol dimethacrylate, trimethylolpropane trimethacrylate, Laromer® BDDA and combinations thereof.

5. The process of any one of embodiments 1-4, wherein the ethylenically unsaturated monomers of the first-stage monomer composition are combination of the ethylenically unsaturated monomer selected from the group consisting of VeoVa™ 10, 2-hydroxyethyl acrylate, 2-hydroxypropyl acrylate, SIPOMER® COPS-I, LATEMUL PD-450, Golpanol® VS, ureido methacrylate, glycidyl methacrylate, diacetone acrylamide paired with adipic dihydrazide via addition of the adipic dihydrazide to the obtained dispersion, with the ethylenically unsaturated monomer selected from the group consisting of 2-ethylhexyl acrylate, butyl acrylate, ethyl acrylate, methyl acrylate, methyl methacrylate, styrene, and vinyl acetate.

6. The process of any one of embodiments 1-5, wherein the base is an aqueous inorganic base, preferably selected from the group consisting of sodium hydroxide, potassium hydroxide and ammonia water.

7. The process of any one of embodiments 1-6, wherein the chain transfer agent is tertiary dodecyl mercaptan and/or 2-ethylhexyl thioglycolate.

8. a pressure sensitive adhesive dispersion obtained from the process of any one of embodiments 1-7.

9. a process for preparing a pressure sensitive adhesive formulation, comprising steps of:

adding a crosslinking agent to the pressure sensitive adhesive dispersion obtained from the process of any one of embodiments 1-7;

optionally, adding additional additives such as wetting agents and thickeners.

10. the process of embodiment 9, wherein when the pressure sensitive adhesive dispersion has a pH value of <7.0, the process further comprises, before the step of adding a crosslinking agent to the pressure sensitive adhesive dispersion, a step of neutralizing the pressure sensitive adhesive dispersion with a base to a pH value of >7.0, preferably below 10.

11. the process of embodiment 10, wherein the base is an aqueous inorganic base, preferably selected from the group consisting of sodium hydroxide, potassium hydroxide and ammonia water.

12. the process of any one of embodiments 9-11, wherein the cross-linking agent is selected from the group consisting of multi-functional aziridine, isocyanate, oxazoline, carbodiimide or combinations thereof, e.g. NEOCRYL® CX-100, XAMA®7, Basonat® DS 3582, Basonat® LR 9056, HYCASYL™ 510.

13. the process of any one of embodiments 9-12, wherein the amount of the cross-linking agent is in the range of 0 to 10% by weight, preferably 0 to 8% by weight, more preferably 0.5 to 5% by weight, such as 1 to 3% by weight, based on the total weight of the pressure sensitive adhesive formulation.

14. a pressure sensitive adhesive formulation obtained from the process of any one of embodiments 9 to 13.

15. a substrate coated with the pressure sensitive adhesive dispersion of embodiment 8 or the pressure sensitive adhesive formulation of embodiment 14, preferably the substrate is selected from the group consisting of tape, sheet, film, plate, and the like, more preferably the substrate is a protective film.

16. use of the pressure sensitive adhesive dispersion of embodiment 8 for preparing a protective film.

17. use of the pressure sensitive adhesive formulation of embodiment 14 for preparing a protective film.

### EXAMPLES

The present invention will be further illustrated hereinafter with the reference of the specific examples which are exemplary and explanatory only and are not restrictive.

Each part and percentage when used, if not defined otherwise, is provided on weight basis. Materials that used in examples:

| | |
|---|---|
| polystyrene seed | concentration: 33%, particle size = 30-40 nm, |
| dispersion | from Shanghai Gaoqiao BASF Dispersions Co., |
| | Ltd., Shanghai, China |
| sodium persulfate | commercially available from Sigma-Aldrich, |
| | St. Louis, MO, USA |
| butyl acrylate | commercially available from BASF SE, |
| | Ludwigshafen, Germany |
| acrylic acid | commercially available from BASF SE, |
| | Ludwigshafen, Germany |
| methacrylic acid | commercially available from BASF SE, |
| | Ludwigshafen, Germany |
| tertiary dodecyl | commercially available from Sigma-Aldrich, |
| mercaptan | St. Louis, MO, USA |
| 2-ethylhexyl | commercially available from Sigma-Aldrich, |
| thioglycolate | St. Louis, MO, USA |
| diacetone acrylamide | commercially available from Sigma-Aldrich, |
| | St. Louis, MO, USA |
| adipic dihydrazide | commercially available from Sigma-Aldrich, |
| | St. Louis, MO, USA |
| ammonia | commercially available from BASF-YPC Co., |
| | Ltd., Nanjing, China |
| styrene | commercially available from BASF SE, |
| | Ludwigshafen, Germany |
| methyl methacrylate | commercially available from BASF SE, |
| | Ludwigshafen, Germany |
| Laromer ® BDDA | commercially available from BASF SE, |
| | Ludwigshafen, Germany |
| LATEMUL PD-450 | commercially available from KAO Chemical, |
| | Shanghai, China |
| Sipomer COPS-1 | commercially available from Solvay Rhodia, |
| | Singapore |
| sodium bisulfite | commercially available from Sigma-Aldrich, |
| | St. Louis, MO, USA |
| Basonat ® LR 9056 | commercially available from BASF SE, |
| | Ludwigshafen, Germany |
| Lumiten ® I-SC | commercially available from BASF SE, |
| | Ludwigshafen, Germany |

### Example 1

### Preparation and Application of Dispersion P01

Into a polymerization vessel, a polystyrene seed dispersion (4 g, solid content 33%) was introduced. The polystyrene seed dispersion was heated and Sodium persulfate (SPS, 7%, 71 g) was added when the temperature reached 80° C. After that, addition of the Mixture 1 (consisting of butyl acrylate 126 g, acrylic acid 22 g, tertiary dodecyl mercaptan 1.3 g) was started. 30 min after the start of addition of Mixture 1, ammonia water (25%, 10.5 g) was added within 45 min. When the above procedures were completed, the addition of Mixture 2 (consisting of butyl acrylate 716 g, styrene 42 g, methyl methacrylate 84 kg, Laromer® BDDA 7.7 g) was commenced, and lasted for 3 h with the simultaneous addition of Sodium persulfate (7%, 71 g) and ammonia water (25%, 21 g).

After the polymerization procedures above, chemical deodorization started. Sodium persulfate 7% 22 g and sodium bisulfite 1.5% 50 g were added to the polymerization vessel. The chemical deodorization lasted for 15 min, followed by cooling and filtration to obtain Dispersion P01 with a solid content of 49.2 wt. %, the particle size of ˜245 nm and pH of 8.3.

The dispersion P01 was formulated with 0.5% Lumiten® I-SC aqueous solution (50 wt. %, a wetting agent) to form the formulation F01a. The formulation F01a was further mixed with 2 and 3 wt. % Basonat® LR 9056 (a crosslinking agent) with vigorous stirring for 30 min, to form the formulations F01b and F01c, respectively. Each of the formulations was cast onto a corona treated polyethylene film respectively, and dried at 70° C. for 3 min to form protective film 01a, protective film 01b and protective film 01c, respectively. The dry weights of the obtained adhesive layers on the film were ˜5 g/m².

### Example 2

### Preparation and Application of Dispersion P02

The dispersion P02 was prepared according to the same procedures as Example 1, except that no polystyrene seed dispersion was included as the initial charge of the polymerization vessel during the emulsion polymerization stages.

The obtained dispersion P02 had a solid content of 44.6%, pH of 5.8 and particle size of ˜212 nm.

The dispersion P02 was neutralized with NaOH solution (8 wt. %) to pH 7.4, and then formulated with 0.5% Lumiten® I-SC aqueous solution (50 wt. %), to form the formulation F02a. The formulation F02a was further mixed with 2 wt. % Basonat® LR 9056 with vigorous stirring for 30 min, to form the formulation F02b. Each of the formulations F02a and F02b was cast onto a corona treated polyethylene films respectively, and dried at 70° C. for 3 min to form protective film 02a and protective film 02b. The dry weights of the obtained adhesive layers on the film were ˜5 g/m².

### Example 3

### Preparation and Application of Dispersion P03

The dispersion P03 was prepared according to the same procedures as Example 1, except that the introduced polystyrene seed dispersion was 3.3 g, and the Mixture 1 consisted of 2-ethylhexyl acrylate 11 g, butyl acrylate 82 g, acrylic acid 16 g, and tertiary dodecyl mercaptan 0.9 g.

The obtained dispersion P03 had a solid content of 44.9%, pH of 6.7 and particle size of ˜203 nm.

The dispersion P03 was neutralized with NaOH solution (8 wt. %) to pH 7.5, and then formulated with 0.5% Lumiten® I-SC aqueous solution (50 wt. %), to form the formulation F03. The formulation F03 was cast onto a corona treated polyethylene film, and dried at 70° C. for 3 min to form a protective film 03. The dry weight of the obtained adhesive layer on the film was ˜5 g/m².

### Example 4

### Preparation and Application of Dispersion P04

The dispersion P04 was prepared according to the same procedures as Example 1, except the reaction temperature was 90° C.

The obtained dispersion P04 had a solid content of 41.9%, pH of 6.2 and particle size of ˜217 nm.

The dispersion P04 was neutralized with NaOH solution (8 wt. %) to pH 7.8, and then formulated with 0.5% Lumiten® I-SC aqueous solution (50 wt. %), to form the formulation F04, after which the formulation F04 was cast onto a corona treated polyethylene film, and dried at 70° C. for 3 min to form a protective film 04. The dry weight of the obtained adhesive layer on the film was ˜5 g/m².

### Example 5

### Preparation and Application of Dispersion P05

The dispersion P05 was prepared according to the same procedures as Example 1, except that the introduced polystyrene seed dispersion was 3.1 g, the Mixture 1 consisted of butyl acrylate 69 g, acrylic acid 19 g, diacetone acrylamide 9.9 g and tertiary dodecyl mercaptan 0.9 g, and after the chemical deodorization, adipic dihydrazide 10.2 g was added into the dispersion before cooling and filtration.

The obtained dispersion P05 has a solid content of 44 wt. %, the particle size of ˜189 nm and pH of 6.5.

The dispersion P05 was neutralized with NaOH solution (8 wt. %) to pH 8.0, and then formulated with 0.5% Lumiten® I-SC aqueous solution (50 wt. %), to form the formulation F05a. The formulation F05a was further mixed with 2 wt. % Basonat® LR 9056 with vigorous stirring for 30 min, to form the formulation F05b. The formulation F05a and formulation F05b were respectively cast onto a corona treated polyethylene film, and dried at 70° C. for 3 min to form a protective film 05a and a protective film 05b. The dry weight of the obtained adhesive layer on the film was ˜5 g/m².

### Example 6

### Preparation and Application of Dispersion P06

The dispersion P06 was prepared according to the same procedures as Example 1, except that the initial charge of the polystyrene seed dispersion was 3.3 g, the Mixture 1 consisted of butyl acrylate 90 g, acrylic acid 18.5 g and 2-ethylhexyl thioglycolate 0.9 g, and the Mixture 2 consisted of butyl acrylate 820 g, styrene 48 g, methyl methacrylate 95 kg, Laromer® BDDA 8.5 g and Sipomer COPS-1 (40 wt. % in water) 11.5 g.

The obtained dispersion P06 has a solid content of 45.7 wt. %, the particle size of ˜195 nm and pH of 6.8.

The dispersion P05 was neutralized with NaOH solution (8 wt. %) to pH 8.0, and then formulated with 0.5% Lumiten® I-SC aqueous solution (50 wt. %), to form the formulation F06a. The formulation F06a was further mixed with 1 wt. % Basonat® LR 9056, 2 wt. % Basonat® LR 9056, 3 wt. % Basonat® LR 9056, 5 wt. % Basonat® LR 9056, 10 wt. % Basonat® LR 9056 respectively, with vigorous stirring for 30 min, to form the formulation F06b, formulation F06c, formulation F06d, formulation F06e and formulation F06f. The formulation F06a, formulation F06b, formulation F06c, formulation F06d, formulation F06e and formulation F06f were cast onto a corona treated polyethylene film respectively, and dried at 70° C. for 3 min to form a protective film 06a, a protective film 06b, a protective film 06c, a protective film 06d, a protective film 06e and a protective film 06f, respectively. The dry weight of the obtained adhesive layer on the film was ˜5 g/m².

### Example 7

### Preparation and Application of Dispersion P07

The dispersion P07 was prepared according to the same procedures as Example 1, except that the introduced polystyrene seed dispersion was 3.3 g, the Mixture 1 consisted of butyl acrylate 93 g, acrylic acid 6.5 g, 2-ethylhexyl thioglycolate 0.9 g and Latemul PD450 11 g, and the Mixture 2 consisted of butyl acrylate 830 g, styrene 50 g, methyl methacrylate 98 kg and Laromer® BDDA 9 g.

The obtained dispersion P07 has a solid content of 45.2 wt. %, the particle size of ˜270 nm and pH of 6.3.

The dispersion P07 was neutralized with NaOH solution (8 wt. %) to pH 8.0, and then formulated with 0.5% Lumiten® I-SC aqueous solution (50 wt. %), and further mixed with 2 wt. % Basonat® LR 9056 with vigorous stirring for 30 min to form the formulation F07, after which the formulation F07 was cast onto a corona treated polyethylene film, and dried at 70° C. for 3 min to form a protective film 07. The dry weight of the obtained adhesive layer on the film was ˜5 g/m².

### Example 8

### Preparation and Application of Dispersion P08

The dispersion P08 was prepared according to the same procedures as Example 1, except that the introduced polystyrene seed dispersion was 3.3 g, the Mixture 1 consisted of butyl acrylate 93 g, methacrylic acid 16 g, tertiary dodecyl mercaptan 0.9 g and Latemul PD450 11 g, the Mixture 2 consisted of butyl acrylate 883 g, methyl methacrylate 98 kg and Laromer® BDDA 8.6 g, and ammonia water (25%, 8.6 g) was used for the two additions of ammonia water respectively.

The obtained dispersion P08 has a solid content of 44.6 wt. %, the particle size of ˜272 nm and pH of 9.1.

The dispersion P08 was formulated with 0.5% Lumiten® I-SC aqueous solution (50 wt. %), and further mixed with 2 wt. % Basonat® LR 9056 with vigorous stirring for 30 min to form the formulation F08, after which the formulation F08 was cast onto a corona treated polyethylene film, and dried at 70° C. for 3 min to form a protective film 08. The dry weight of the obtained adhesive layer on the film was ˜5 g/m².

### Example 9

### Adhesive Performance Tests and Results of the Protective Film Application

The protective film 01a obtained from example 1 was applied on a steel panel to form a covered steel panel. Then the covered steel panel was aged for 7 days at 70° C., 85% relative humidity. After that, the protective film 01a was peeled off from the steel panel. Then the appearance of the obtained naked steel panel was observed and the result was reported in following tables.

Above procedure was repeated, respectively using the protective films 01b, 01c, 02a, 02b, 03, 04, 05a, 05b, 06a, 06b, 06c, 06d, 06e, 06f, 07, 08 instead. Series 1 of the test corresponds to protective films 01a, 01b, 01c; Series 2 of the test corresponds to protective films 02a, 02b; Series 3 of the test corresponds to protective film 03; Series 4 of the test corresponds to protective film 04; Series 5 of the test corresponds to protective films 05a, 05b; Series 6 of the test corresponds to protective films 06a, 06b, 06c, 06d, 06e, 06f; Series 7 of the test corresponds to protective film 07; Series 8 of the test corresponds to protective film 08.

To evaluate the adhesive performance of the protective film, the appearance of each test was ranked by a ranking system as follow:

Rank 1: Clean, no residue, no visible shadow when observed vertically to the surface of the steel panel under regular indoor daylight, however when observed from a direction having an angle to vertical direction to the observed surface, very slight shadow was observed;

Rank 2: Clean, no residue, no visible shadow when observed the surface of the steel panel under regular indoor daylight, however when observed under illumination of a close light source, very slight shadow was observed

Rank 3: Clean, no residue, no visible shadow when observed under regular indoor daylight, however when observed under illumination of a close light source and from a direction having an angle to vertical direction to the observed surface, very slight shadow was observed;

Rank 4: Clean, no residue, no visible shadow when observed under illumination of a close light source from almost all possible observing angles.

Results are provided in following table 1.

TABLE 1
Adhesive performance tests and results
of the protective film application

| | | Crosslinking | | | Rank of the |
|---|---|---|---|---|---|
| Test | | agent | | protec- | appearance of |
| Series | Disper- | Basonat ® LR | formula- | tive | the naked |
| No. | sions* | 9056 | tion* | film | steel panel |
| 1 | P01 | 0 wt. % | F01a | 01a | Rank 2 |
| | P01 | 2 wt. % | F01b | 01b | Rank 3 |
| | P01 | 3 wt. % | F01c | 01c | Rank 3 |
| 2 | P02 | 0 wt. % | F02a | 02a | Rank 1 |
| | P02 | 2 wt. % | F02b | 02b | Rank 3 |
| 3 | P03 | 0 wt. % | F03 | 03 | Rank 1 |
| 4 | P04 | 0 wt. % | F04 | 04 | Rank 1 |
| 5 | P05 | 0 wt. % | F05a | 05a | Rank 3 |
| | P05 | 2 wt. % | F05b | 05b | Rank 4 |
| 6 | P06 | 0 wt. % | F06a | 06a | Rank 2 |
| | P06 | 1 wt. % | F06b | 06b | Rank 3 |
| | P06 | 2 wt. % | F06c | 06c | Rank 4 |
| | P06 | 3 wt. % | F06d | 06d | Rank 4 |
| | P06 | 5 wt. % | F06e | 06e | Rank 4 |
| | P06 | 10 wt. % | F06f | 06f | Rank 4 |
| 7 | P07 | 2 wt. % | F07 | 07 | Rank 3 |
| 8 | P08 | 2 wt. % | F08 | 08 | Rank 3 |

*formulated with 0.5% Lumiten ® I-SC as the wetting agent and pH > 7.3

The percentage of the crosslinking agent was provided on the basis of the total weight of the formulation.

As can be seen from the data in Table 1,

All the protective films obtained from the invention can result in a surface having a clean, no residue, no visible shadow appearance when observed vertically to the surface of the steel panel under regular illumination;

The addition of the crosslinker will make the appearance of the surface better, as can be seen from series No. 1, 2, 5 and 6.

Example 5 for preparing protective film 05 series used monomer combination of DAAM/ADH, the results of this test series 5 are generally better than that of the test series 2.

Example 6 for preparing protective film 06 series further used a functional monomer, the results of this test series 6 are generally better than that of the test series 2.

The present invention is not to be limited in scope by the specific embodiments and examples described herein. Indeed, various modifications of the invention in addition to those described herein will become apparent to those skilled in the art from the foregoing description and the accompanying figures. Such modifications are intended to fall within the scope of the appended claims.

It is further to be understood that all values are approximate, and are provided for description.

1. A process for preparing a pressure sensitive adhesive dispersion, the process comprising:
1) performing a first emulsion polymerization comprising
i) forming a first-stage dispersion by polymerizing a first-stage monomer composition consisting of at least one ethylenically unsaturated monomer and at least one carboxylic acid group containing ethylenically unsaturated monomer, to form the first-stage dispersion comprising a first-stage polymer particle in an aqueous medium, such that a proportion of the carboxylic acid group containing ethylenically unsaturated monomer is at least 1.0 wt % of the first-stage monomer composition,
ii) adding a chain transfer agent to the first-stage monomer composition, such that an addition amount of the chain transfer agent is 0.3-1.5 wt %, based on the weight of the first-stage monomer composition, and
iii) neutralizing the first-stage dispersion with an aqueous base solution to a pH value of between 5.0 and 7.0 to form a neutralized first-stage dispersion; and
2) performing a second emulsion polymerization in the presence of the neutralized first-stage dispersion, by polymerizing a second-stage monomer composition consisting of at least one ethylenically unsaturated monomer and optionally at least one multi-ethylenically unsaturated monomer into the first-stage polymer particles to form second-stage polymer particles, and thereby obtaining a pressure sensitive adhesive dispersion,
wherein a weight ratio of the first-stage monomer composition to a total weight of the first-stage monomer composition and the second-stage monomer composition is in 5-50 wt %.

2. The process of claim 1, wherein the first emulsion polymerization, the second emulsion polymerization, or both, occurs in the presence of a water soluble initiator.

3. The process of claim 1, wherein an amount of the multi-ethylenically unsaturated monomer in the second-stage monomer composition is 0.3-2.0 wt.

4. The process of claim 1, wherein:
the ethylenically unsaturated monomers of the first-stage monomer composition are selected from the group consisting of (meth)acrylates with/without functional groups, vinyl and allyl monomers with/without functional groups, other functional ethylenically unsaturated monomers and combinations thereof;
the carboxylic acid group containing ethylenically unsaturated monomers of the first-stage monomer composition are selected from the group consisting of acrylic acid, methacrylic acid and itaconic acid, and combinations thereof;
the ethylenically unsaturated monomers of the second-stage monomer composition are selected from the group consisting of 2-ethylhexyl acrylate, butyl acrylate, ethyl acrylate, methyl acrylate, methyl methacrylate, styrene, vinyl acetate, vinyl and allyl monomers with/without functional groups, 2-hydroxyethyl acrylate, 2-hydroxypropyl acrylate, other functional ethylenically unsatured monomers, ureido methacrylate, glycidyl methacrylate, and diacetone acrylamide paired with adipic dihydrazide via addition of the adipic dihydrazide to the obtained dispersion, and combinations thereof; and
the multi-ethylenically unsaturated monomers are selected from the group consisting of divinylbenzene, allyl methacrylate, diethylene glycol dimethacrylate, trimethylolpropane trimethacrylate, and combinations thereof.

5. The process of claim 1, wherein the ethylenically unsaturated monomers of the first-stage monomer composition are at least one selected from the group consisting of vinyl and allyl monomers with/without functional groups, 2-hydroxyethyl acrylate, 2-hydroxypropyl acrylate, other functional ethylenically unsatured monomers, ureido methacrylate, glycidyl methacrylate, diacetone acrylamide paired with adipic dihydrazide via addition of the adipic dihydrazide to the obtained dispersion, with the ethylenically unsaturated monomer selected from the group consisting of 2-ethylhexyl acrylate, butyl acrylate, ethyl acrylate, methyl acrylate, methyl methacrylate, styrene, and vinyl acetate.

6. The process of claim 1, wherein the aqueous base is an aqueous inorganic base.

7. The process of claim 1, wherein the chain transfer agent is tertiary dodecyl mercaptan, 2-ethylhexyl thioglycolate, or both.

8. A pressure sensitive adhesive dispersion obtained from the process of claim 1.

9. A process for preparing a pressure sensitive adhesive formulation, the process comprising:
adding a crosslinking agent to a pressure sensitive adhesive dispersion obtained from the process of claim 1; and
optionally, adding at least one additional additive.

10. The process of claim 9, wherein:
when the pressure sensitive adhesive dispersion has a pH value of <7.0; and
the process further comprises, before the step of adding a crosslinking agent to the pressure sensitive adhesive dispersion, a step of neutralizing the pressure sensitive adhesive dispersion with a base to a pH value of >7.0.

11. The process of claim 10, wherein the base is an aqueous inorganic base.

12. The process of claim 9, wherein the cross-linking agent is selected from the group consisting of a multi-functional aziridine, an isocyanate, an oxazoline, a carbodiimide or combinations thereof.

13. The process of claim 9, wherein an amount of the cross-linking agent is 0 to 10% by weight, based on a total weight of the pressure sensitive adhesive formulation.

14. A pressure sensitive adhesive formulation obtained from the process of claim 9.

15. A substrate coated with the pressure sensitive adhesive dispersion of claim 8.

16. A protective film prepared from the pressure sensitive adhesive dispersion of claim 8.

17. A protective film prepared from the pressure sensitive adhesive formulation of claim 14.
